(19) United States
(12) Patent Application Publication
(10) Pub. No.: US 2008/0178470 A1
(43) Pub. Date: Jul. 31, 2008

(54) ADJUSTABLE PIE CUTTER

(75) Inventor: Sarah S. Peterson, Philadelphia, PA (US)

Correspondence Address: BLACK LOWE & GRAHAM, PLLC, 701 FIFTH AVENUE, SUITE 4800, SEATTLE, WA, 98104, US

(73) Assignee: Progressive International Corporation, Kent, WA (US)

(21) Appl. No.: 12/023,833

(22) Filed: Jan. 31, 2008

Related U.S. Application Data
(60) Provisional application No. 60/887,503, filed on Jan. 31, 2007.

(51) Int. Cl. A21C 15/04; B26B 27/00

(52) U.S. Cl. 30/114; 30/298

(57) ABSTRACT

A slicing device that is able to cut a pie or other similar item into a number of pieces in which the size of each piece is substantially fixed prior to cutting. In the example of the invention, the pie is cut into a number of pieces in which each piece is substantially the same size as each of the other pieces. For example, the pie cutter may cut the pie into eight pieces, with each of the eight pieces being the same size. In some examples of the invention, the device can be reconfigured or adjusted so that it can cut the pie into a different number of pieces.

### PRIORITY CLAIM

This application claims the benefit of prior U.S. application Ser. No. 60/887,503, filed Jan. 31, 2007.

### FIELD OF THE INVENTION

This invention relates generally to cutting devices, particularly including devices for cutting pies or similar baked goods.

### BACKGROUND OF THE INVENTION

Currently, pies or similar baked goods are cut using a knife or the edge of a pie serving tool. While these devices are able to cut through the pie, they are no help at all in ensuring that the pie is cut evenly into the desired number of pieces. There is a need for a device that can cut a pie into even-sized pieces.

### SUMMARY OF THE INVENTION

The invention comprises a device that is able to cut a pie or other similar item into a number of pieces in which the size of each piece is substantially fixed prior to cutting. In the example of the invention as shown, the pie is cut into a number of pieces in which each piece is substantially the same size as each of the other pieces. For example, the pie cutter may cut the pie into eight pieces, with each of the eight pieces being the same size. In some examples of the invention, the device can be reconfigured or adjusted so that it can cut the pie into a different number of pieces. For example, a single device may be constructed so that it can optionally cut the pie into either six or eight even pieces, as desired. In other examples of the invention, the pie cutter can be configured to cut the pie into a number of pieces that are differently sized from one another, but in a size relationship that is predetermined prior to cutting.

### BRIEF DESCRIPTION OF THE DRAWINGS

Preferred and alternative embodiments of the present invention are described in detail below with reference to the following drawings:

FIG. 1 is a top perspective view of an example of the invention;

FIG. 2 is a top plan view of an example of the invention;

FIG. 3 is a bottom perspective view of an example of the invention;

FIG. 4 is a side view of an example of the invention; and

FIG. 5 is an exploded view of an example of the invention.

### DETAILED DESCRIPTION OF THE PREFERRED EMBODIMENT

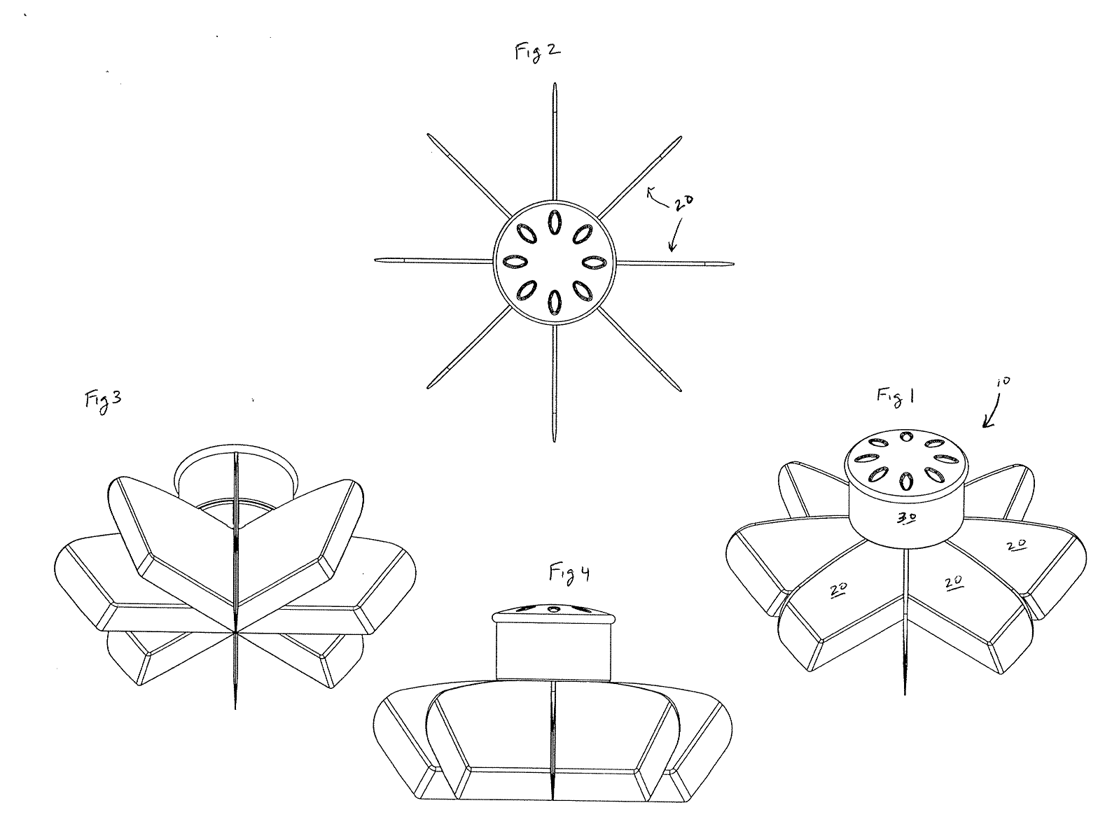

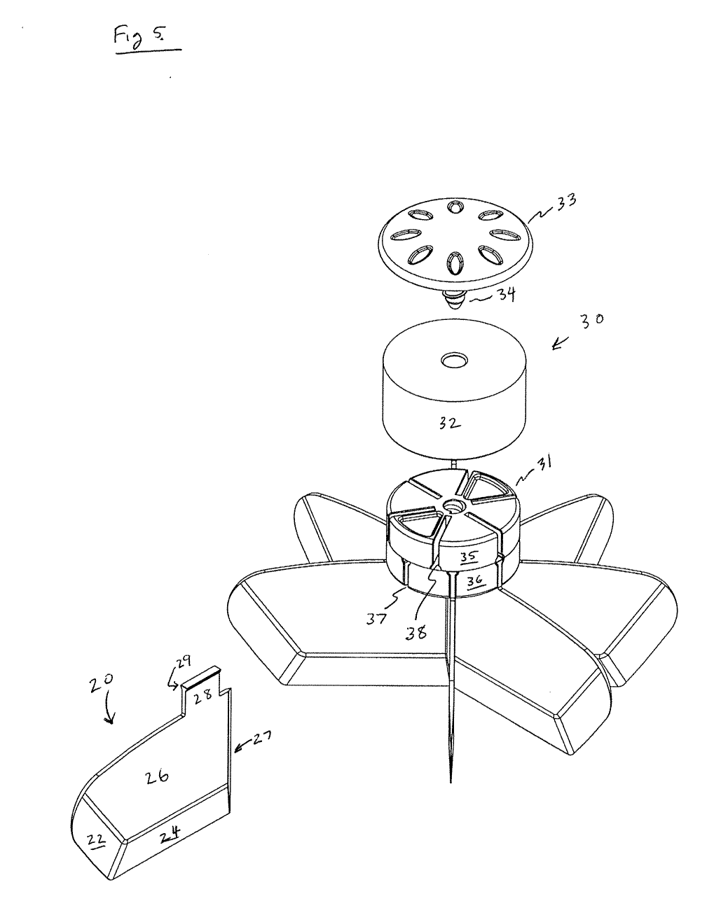

FIG. 1 illustrates a perspective view of an example of the invention. In the version shown in FIG. 1, the pie cutter is configured with eight blades 20 that are evenly spaced in order to cut a pie into eight even pieces. It should be understood that while the term “pie cutter” is used for convenience, the cutting device as shown and described can be readily used for cutting other food items such as cakes, cheesecakes, pastries, and other items.

Each of the blades 20 is held in place by a cap assembly 30. In the form as shown, the cap assembly includes mechanical structures to hold the blades in the desired spatial relationships, although in other forms of the invention the blades may be fixed using other structures that are separated from the cap assembly. In one example, the blades can be permanently affixed to one another at the center of the pie cutter such that each of the blades extends radially outward from a central axis.

As best seen in FIG. 5, the preferred form of the blade 20 includes a main blade body 26, a sharpened lower portion 24, and a sharpened outer portion 22. The blades may be formed from plastic, stainless steel, or other suitable materials. The lower portion 22 is preferably generally straight and has an edge that is orthogonal to a first end of the blade as well as a central axis extending through the cap assembly when the blade is attached to the cap assembly. The sharpened outer portion 22 has an edge that is inclined somewhat from the vertical (that is, a line parallel to the central axis of the cap assembly), forming an obtuse angle consistent with the incline of the perimeter of a typical pie pan.

The blade 20 includes an axial edge 27 that, when the blade is attached to the cap assembly 30, is aligned with or closely adjacent the central axis extending through the cap assembly. A tab 28 extends axially upward in a direction opposite from the lower edge 24, and includes a pair of flanges 29 at the top of the tab 28 and orthogonal to the tab.

In the example as illustrated, the cap assembly 30 includes a rigid core 31 having a top section 35 and a bottom section 36. Each of the pieces of the cap assembly are preferably formed from plastic, but could alternatively be formed from nearly any material such as stainless steel or wood. The core 31 is received within a cylindrical cover 32 and is held in place within the cover by a cap 33. As shown, a threaded fastener 34 attached to and extending downward from the cap mates with a complementary threaded slot within the core 31 to secure the cap, cover, and core together. The threaded fastener 34 projects axially downward and defines the central axis of the cap assembly. Alternative forms, such as snap fittings and the like may be used instead. Likewise, the threaded fastener need not extend through the central axis. For that matter, the cap and cover may be excluded altogether, and the device may instead use only the core 31 or similar structure to join the blades together in a desired configuration.

As shown and described, the core 31 includes a top section 35 and a bottom section 36. The top section includes six slots 38, with each of the slots being sized and shaped to snugly receive the “T” shape of the tab 28 and flange 29 combination from any one of the blades 20. The bottom section includes eight slots 37 that are configured in the same manner. Either the top or bottom sections may have a different number of slots (for example, 4, 5, 7, 9, or 10) to enable the pie to be cut in a corresponding number of pieces. In a device configured with a single core piece 31, the pie cutter can be configured to cut a pie into any two different numbers of pieces.

In alternate forms, however, the pie cutter is accompanied by a plurality of core pieces with many different numbers of slots 37, 38. By mating a desired core within the cap assembly and inserting the blades, the pie cutter can then cut the pie into the desired number of pieces.

In yet other examples of the invention, a plurality of core sections 31 are sized and shaped so that the cover 32 can retain the plurality of core sections within it at the same time. For example, a first core having an upper section with four slots and a lower section with five slots, plus a second core having six and seven slots, and a third core having eight and nine slots may all be simultaneously retained within a cover 32 so long as the cover is the appropriate size to accommodate them. Similarly, in such an embodiment the cap 33 preferably includes a fastener 34 (threaded or otherwise) that is sufficiently long to extend through all three cores. Alternatively, each of the plurality of cores may be snap-fit or otherwise secured to one another, either with or without the use of a cover and threaded fastener.

In the preferred examples of the invention as described, the core sections include slots that are evenly spaced to cut the pie into an even number of pieces. In some examples of the invention the slots within the core sections are unevenly spaced. For example, it may be desirable to cut a pie into eight pieces, wherein four of them are somewhat larger and four are somewhat smaller. By configuring the slots within the core in the appropriate spacing, the pie can be cut in that manner.

In order to use the pie cutter, the proper blade orientation is chosen and the blades are attached to the appropriate core. If a cover and cap are included, the cover and cap are attached as described above. The pie cutter is then placed over the pie and pressed straight down in order to cut the pie into the chosen number of pieces. The cap assembly is useful for this purpose, and preferably includes a top surface that is sized and shaped to be pressed by the palm of a hand or to be gripped within the palm of a hand. In alternate forms of the invention, not shown, a handle is provided to be grasped to press the pie cutter downward.

After the pie has been cut, the pie cutter can remain in place when pieces are removed. This provides a number of advantages. When the pie is of a type that has juices that flow readily the pie cutter can help to retain the filling within each piece separately rather than allowing it to flow into the space vacated by a piece of pie that has been removed. In addition, the blade seals the filling of the pie for those pieces that are not removed from the pan. By leaving the pie cutter in place when a portion of the pie is not immediately consumed, the remaining pieces stay fresher than they would otherwise if the pie cutter is not left in place.

While the preferred embodiment of the invention has been illustrated and described, as noted above, many changes can be made without departing from the spirit and scope of the invention.

I claim:

1. A food slicing device, comprising:
a plurality of blades, each one of the plurality of blades having a top edge and an opposite bottom edge, each of the plurality of blades having a first end and a second end, the first ends of each of the blades being positioned adjacent one another at a central axis such that the second ends of each of the blades extend radially outward from the central axis; and
a core secured to the plurality of blades relatively closer to the top edge than to the bottom edge to hold the blades in position.

2. The food slicing device of claim 1, wherein the core further comprises a first plurality of slots and each of the plurality of blades further comprises a tab, each of the first plurality of slots being sized and configured to receive a corresponding one of the plurality of tabs.

3. The food slicing device of claim 2 wherein each of the plurality of blades includes a pair of flanges orthogonal to each of the tabs, the pair of flanges being configured to retain the tabs within a respective one of the first plurality of slots.

4. The food slicing device of claim 3, wherein each of the tabs are coplanar with the blades, and further wherein the core includes a central axis, each of the first plurality of slots radiating axially outward from the central axis.

5. The food slicing device of claim 4, further comprising a cap secured to the core, the cap being configured to substantially surround the core to retain the blades in position.

6. The food slicing device of claim 5 wherein the core further comprises a top portion and a bottom portion, the first plurality of slots being positioned within the bottom portion, the core further comprising a second plurality of slots positioned within the top portion.

7. The food slicing device of claim 6, wherein the first plurality of slots comprises six slots and the second plurality of slots comprises eight slots.

8. The food slicing device of claim 5, wherein the bottom edge of each of the plurality of blades is relatively sharper than the top edge.

9. The food slicing device of claim 5, wherein the first end of each of the plurality of blades is substantially orthogonal to the bottom edge and the second end of the plurality of blades forms an obtuse angle with respect to the bottom edge.

10. The food slicing device of claim 5, wherein the core and cap are substantially cylindrical.

11. The food slicing device of claim 5, wherein each of the plurality of blades is removable from the plurality of slots.

12. The food slicing device of claim 5, wherein the core abuts the top edge of the plurality of blades.

13. The food slicing device of claim 1, wherein the blades are permanently secured to the core.

14. The food slicing device of claim 1, wherein the device is sized to slice a pie within a pie pan.
